(19) United States
(12) Patent Application Publication
(10) Pub. No.: US 2026/0062885 A1
(43) Pub. Date: Mar. 5, 2026

(54) WORK MACHINE

(71) Applicant: HITACHI CONSTRUCTION MACHINERY CO., LTD., Tokyo (JP)

(72) Inventors: Teruki IGARASHI, Tsuchiura-shi (JP); Ryouhei FUKUCHI, Tsuchiura-shi (JP); Shouta ISHIDA, Tsuchiura-shi (JP); Ryousuke ITOU, Tsuchiura-shi (JP); Akihiro NARAZAKI, Tsuchiura-shi (JP)

(21) Appl. No.: 19/165,212

(22) PCT Filed: Feb. 2, 2024
(86) PCT No.: PCT/JP2024/003407

§ 371 Date: Sep. 15, 2025

(30) Foreign Application Priority Data
Mar. 30, 2023 (JP) 2023-056622

(51) Int. Cl. E02F 3/43; E02F 3/32; E02F 3/42; E02F 9/22; F15B 13/04; F15B 13/044

(52) U.S. Cl. CPC E02F 3/437; E02F 3/32; E02F 3/425; E02F 9/2203; E02F 9/2285; F15B 13/0401; F15B 13/044; E02F 9/2292; E02F 9/2296

(57) ABSTRACT

The present invention provides a work machine that can improve the accuracy of control to limit the operation of the work device within a predetermined range. The excavator includes a control valve that controls the flow of pressure oil to the boom hydraulic cylinder, multiple pilot solenoid valves that generate and output pilot pressure to operate the control valve, a controller with a limiting function that controls the multiple pilot solenoid valves to restrict the operation of the work device to a predetermined range, anti-drop valves with an anti-drop function to prevent the boom from falling, and solenoid valves that output release pressure to release the anti-drop function of the anti-drop valves. The controller calculates the release pressure for the anti-drop valves based on information related to the limiting function and controls the solenoid valves to output the calculated release pressure to the anti-drop valves as a signal to release the anti-drop function.

### TECHNICAL FIELD

The present invention relates to work machines such as excavators.

### BACKGROUND ART

It is known that excavators which are a type of work machine are equipped with anti-drop valves that have an anti-drop function to prevent the boom from falling. For example, the anti-drop valve shown in Patent Document 1 includes a poppet valve body provided in the oil passage between the bottom side of the boom hydraulic cylinder and the boom control valve, and a spool valve body that moves the poppet valve body. When the poppet valve body is in the shut-off position and the pressure on the boom control valve side increases, the poppet valve body moves from the shut-off position. This allows the supply of pressure oil to the bottom side of the boom hydraulic cylinder, and consequently, permits the raising of the boom. When the poppet valve body is in the shut-off position and the pressure on the boom control valve side decreases due to reasons such as pipe breakage, the poppet valve body does not move from the shut-off position. This prevents the discharge of pressure oil from the bottom side of the boom hydraulic cylinder, and consequently, prevents the boom from falling.

The anti-drop valve of Patent Document 1 is configured to receive pilot pressure generated by the pilot valve of the operation device to release the aforementioned anti-drop function. When the operator intends to lower the boom and operates the operation device, the spool valve body moves by an amount corresponding to the pilot pressure generated by the pilot valve of the operation device, and the poppet valve body moves by a corresponding amount. This releases the anti-drop function. That is, it allows the discharge of pressure oil from the bottom side of the boom hydraulic cylinder, and consequently, permits the lowering of the boom.

### PRIOR ART DOCUMENT

### Patent Documents

Patent Document 1: JP 2004-060834 A

### SUMMARY OF THE INVENTION

### Problem to be Solved by the Invention

In recent years, excavators with restriction functions that limit the operation of work devices to a predetermined range to assist or support operators have been proposed. The controller of this excavator controls the control valve by controlling a pilot solenoid valve that generates and outputs pilot pressure to operate the control valve. This controls the operation of the work device so that, for example, the tip of the bucket moves along a predetermined target surface, or the work device does not deviate from a predetermined work area.

When considering the adoption of the anti-drop valve of Patent Document 1 and the configuration to output the pilot pressure generated by the pilot valve of the operation device to the anti-drop valve to release its anti-drop function for the excavator with the aforementioned restriction function, the following issues arise. The magnitude of the pilot pressure to release the anti-drop function of the anti-drop valve varies due to individual differences in the anti-drop valve. Therefore, when executing control to limit the operation of the work device to a predetermined range, the start or stop timing of the boom may deviate from the target value, potentially reducing control accuracy.

The present invention has been made in view of the above matters, and its purpose is to provide a work machine that can improve the accuracy of control that limits the operation of the work device to a predetermined range.

### Means for Solving the Problem

To achieve the above object, the work machine of the present invention includes a multi-joint type work device having at least one connecting member and attachment that can rotate in the vertical direction, a hydraulic cylinder for rotating the connecting member, a control valve for controlling the flow of pressure oil to the hydraulic cylinder, multiple pilot solenoid valves that generate pilot pressure to operate the control valve and output it to the control valve, and a controller with a restriction function to control the multiple pilot solenoid valves to limit the operation of the work device to a predetermined range. Furthermore, the work machine includes an anti-drop valve with an anti-drop function to prevent the connecting member from falling, and a solenoid valve that outputs release pressure to the anti-drop valve to release the anti-drop function. Then, the controller calculates the release pressure of the anti-drop valve based on information related to the restriction function that controls the multiple pilot solenoid valves. Furthermore, the controller controls the solenoid valve to output the calculated release pressure to the anti-drop valve as a signal to release the anti-drop function.

### Advantages of the Invention

According to the present invention, it is possible to improve the accuracy of control that limits the operation of the work device to a predetermined range.

### BRIEF DESCRIPTION OF THE DRAWINGS

FIG. 1 is a side view showing the structure of an excavator in the first embodiment of the present invention.

FIG. 2 is a diagram showing the configuration of a hydraulic system in the first embodiment of the present invention.

FIG. 3 is a block diagram showing the physical configuration of the controller in the first embodiment of the present invention along with related equipment.

FIG. 4 is a block diagram showing the functional configuration of the controller in the first embodiment of the present invention along with related equipment.

FIG. 5 is a diagram showing the excavator coordinate system in the first embodiment of the present invention.

FIG. 6 is a diagram showing the screen of a display device in the first embodiment of the present invention.

FIG. 7 is a diagram showing the correlation table between the operation amount of the operation lever and the pilot pressure in the first embodiment of the present invention.

FIG. 8 is a diagram for explaining movement trace control in the first embodiment of the present invention, showing the target velocity vector of the target surface and the reference point of the bucket.

FIG. 9 is a diagram showing the process of setting the release pressure of the boom solenoid valve in the first embodiment of the present invention.

FIG. 10 is a diagram showing the process of setting the release pressure of the arm solenoid valve in the first embodiment of the present invention.

FIG. 11 is a diagram showing the relationship between the release pressure and the opening rate of the anti-drop valve in the first embodiment of the present invention.

FIG. 12 is a diagram showing the process of setting the release pressure of the boom solenoid valve in the first modification example of the present invention.

FIG. 13 is a diagram showing the calculation table of the release pressure in the second modification example of the present invention.

FIG. 14 is a diagram showing the calculation table of the release pressure in the third modification example of the present invention.

FIG. 15 is a diagram showing the process of setting the release pressure of the boom solenoid valve in the fourth modification example of the present invention.

FIG. 16 is a diagram for explaining deviation prevention control in the second embodiment of the present invention, showing the work area.

FIG. 17 is a block diagram showing the functional configuration of the controller in the second embodiment of the present invention along with related equipment.

FIG. 18 is a diagram showing the process of setting the release pressure of the boom solenoid valve in the second embodiment of the present invention.

FIG. 19 is a diagram showing the process of setting the release pressure of the arm solenoid valve in the second embodiment of the present invention.

FIG. 20 is a diagram showing the calculation table of the release pressure in the fifth modification example of the present invention.

FIG. 21 is a diagram showing the calculation table of the release pressure in the sixth modification example of the present invention.

### MODE FOR CARRYING OUT THE INVENTION

The first embodiment of the present invention will be described with reference to the drawings.

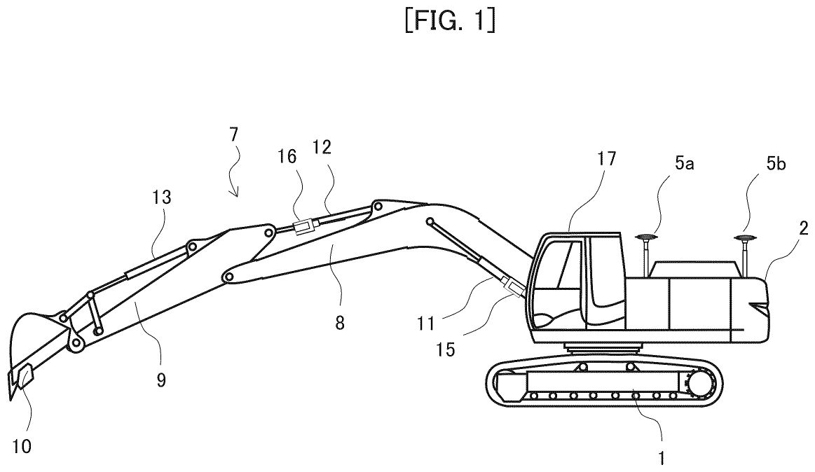

FIG. 1 is a side view showing the structure of the excavator in this embodiment.

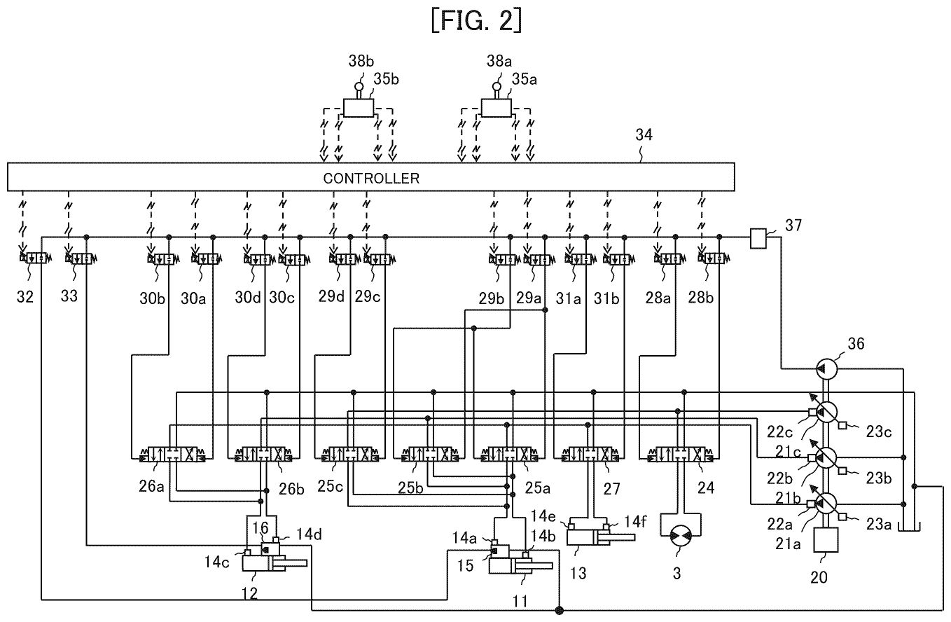

In this embodiment, the excavator includes a travel body 1 capable of traveling and a swing body 2 provided on the upper side of the travel body 1 in a rotatable manner. The travel body 1 and the swing body 2 constitute the vehicle body. The travel body 1 travels by the rotation of left and right travel hydraulic motors (not shown), and the swing body 2 swings by the rotation of the swing hydraulic motor 3 (see FIG. 2 below).

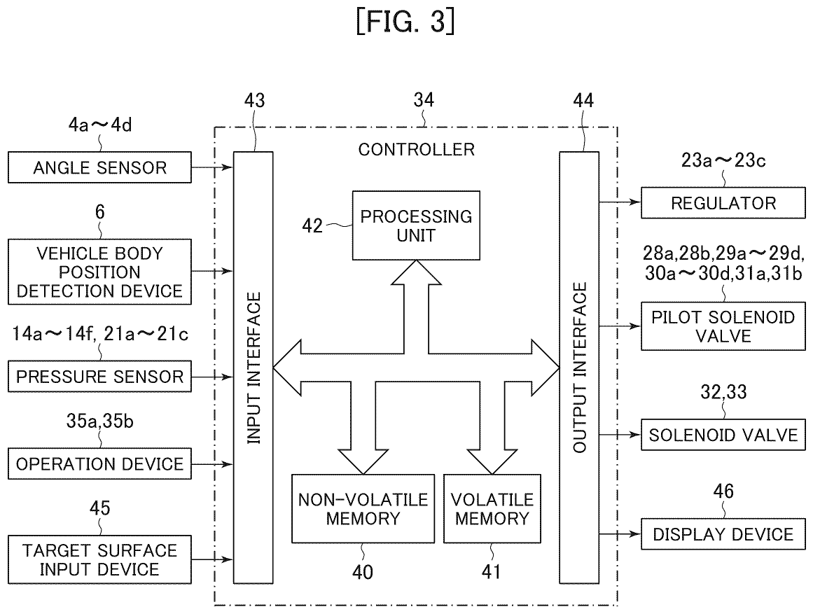

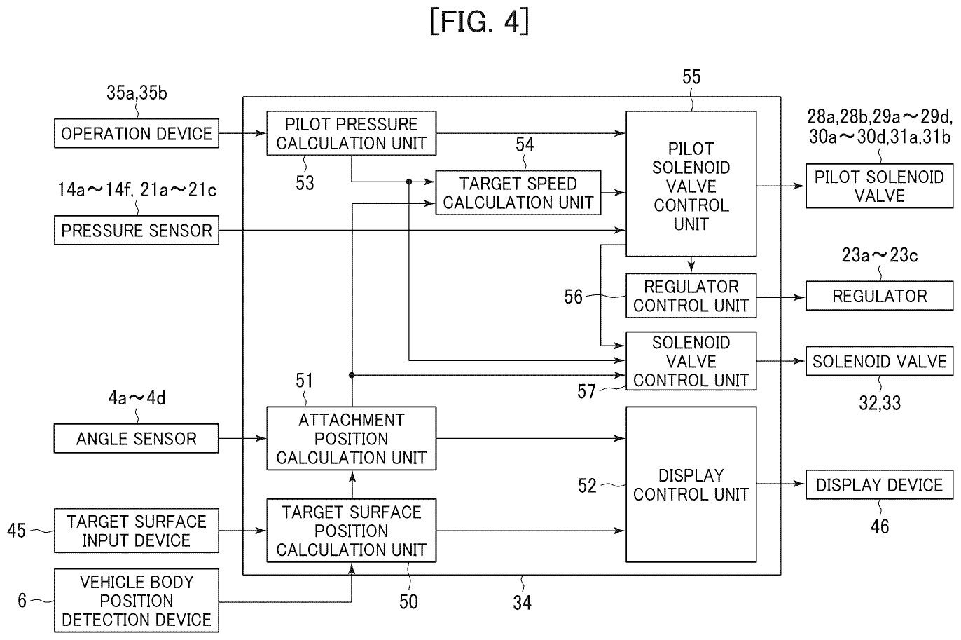

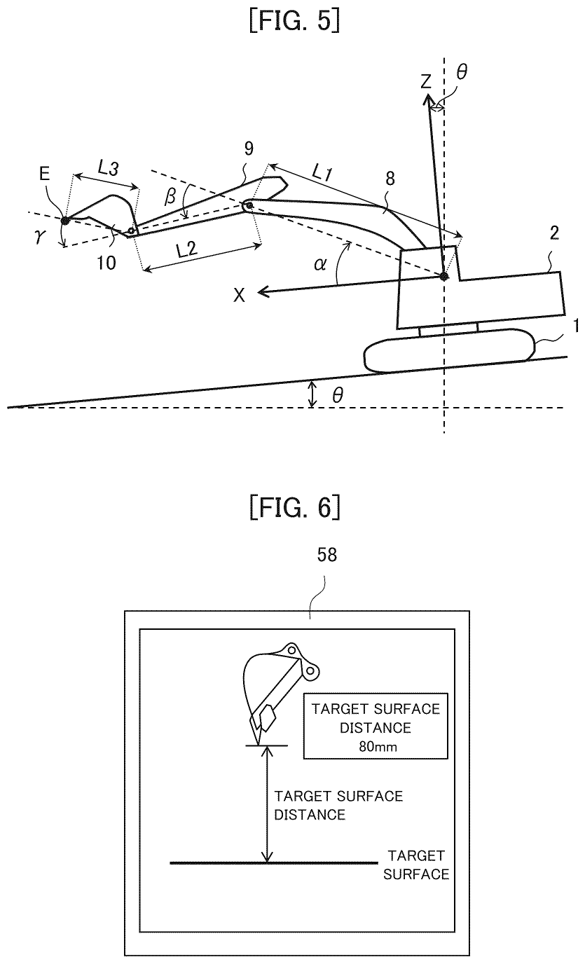

The swing body 2 includes an angle sensor 4a (see FIGS. 3 and 4 below) that detects the inclination angle θ of the vehicle body with respect to the horizontal plane (see FIG. 5 below), and a vehicle body position detection device 6 (see FIGS. 3 and 4 below) that detects the position and orientation of the vehicle body in the global coordinate system based on signals from multiple satellites received by antennas 5a and 5b.

The excavator includes a work device 7 connected to the front side of the swing body 2 (left side in FIG. 1). The work device 7 includes a boom 8 (connecting member) vertically rotatably connected to the swing body 2, an arm 9 (connecting member) vertically rotatably connected to the tip part of the boom 8, and a bucket 10 (attachment) vertically rotatably connected to the tip part of the arm 9. The boom 8 rotates by the extension and compression of the boom hydraulic cylinder 11, the arm 9 rotates by the extension and compression of the arm hydraulic cylinder 12, and the bucket 10 rotates by the extension and compression of the bucket hydraulic cylinder 13. The bucket 10 is interchangeable with other attachments.

The work device 7 includes an angle sensor 4b (see FIG. 3 and FIG. 4 below) for detecting the rotation angle α of the boom 8 relative to the swing body 2 (see FIG. 5 below), an angle sensor 4c (see FIG. 3 and FIG. 4 below) for detecting the rotation angle β of the arm 9 relative to the boom 8 (see FIG. 5 below), and an angle sensor 4d (see FIG. 3 and FIG. 4 below) for detecting the rotation angle γ of the bucket 10 relative to the arm 9 (see FIG. 5 below).

The work device 7 includes pressure sensors 14a, 14b (see FIG. 2 below) for detecting the bottom side pressure and rod side pressure of the boom hydraulic cylinder 11, pressure sensors 14c, 14d (see FIG. 2 below) for detecting the bottom side pressure and rod side pressure of the arm hydraulic cylinder 12, and pressure sensors 14e, 14f (see FIG. 2 below) for detecting the bottom side pressure and rod side pressure of the bucket hydraulic cylinder 13.

The work device 7 includes a boom anti-drop valve 15 with an anti-drop function to prevent the drop of the boom 8, and an arm anti-drop valve 16 with an anti-drop function to prevent the drop of the arm 9.

The boom anti-drop valve 15 includes a poppet valve body (not shown) provided in the oil passage between the bottom side of the boom hydraulic cylinder 11 and the boom control valve described later, and a spool valve body (not shown) for moving the poppet valve body. When the poppet valve body is in the shut-off position, if the pressure on the boom control valve side increases, the poppet valve body moves from the shut-off position (in other words, it opens). This allows the supply of pressure oil to the bottom side of the boom hydraulic cylinder 11, and consequently, permits the raising of the boom 8. When the poppet valve body is in the shut-off position, if the pressure on the boom control valve side decreases due to reasons such as pipe breakage, the poppet valve body does not move from the shut-off position. This prevents the discharge of pressure oil from the bottom side of the boom hydraulic cylinder 11, and consequently, prevents the drop of the boom 8.

The boom anti-drop valve 15 is configured to input a release pressure (details will be described later) to release the aforementioned anti-drop function. When the release pressure is input, the spool valve body moves by an amount corresponding to the release pressure, and the poppet valve body moves by a corresponding amount (in other words, it opens). This releases the anti-drop function. That is, it allows the discharge of pressure oil from the bottom side of the boom hydraulic cylinder 11, and consequently, permits the lowering of the boom 8.

The arm anti-drop valve 16 includes a poppet valve body (not shown) provided in the oil passage between the rod side of the arm hydraulic cylinder 12 and the arm control valve described later, and a spool valve body (not shown) for moving the poppet valve body. When the poppet valve body is in the shut-off position, if the pressure on the arm control valve side increases, the poppet valve body moves from the shut-off position (in other words, it opens). This allows the supply of pressure oil to the rod side of the arm hydraulic cylinder 12, and consequently, permits the dump of the arm 9. When the poppet valve body is in the shut-off position, if the pressure on the arm control valve side decreases due to reasons such as pipe breakage, the poppet valve body does not move from the shut-off position. This prevents the discharge of pressure oil from the rod side of the arm hydraulic cylinder 12, and consequently, prevents the crowd of the arm 9.

The arm anti-drop valve 16 is configured to input a release pressure (details will be described later) to release the aforementioned anti-drop function. When the release pressure is input, the spool valve body moves by an amount corresponding to the release pressure, and the poppet valve body moves by a corresponding amount (in other words, it opens). This releases the anti-drop function. That is, it allows the discharge of pressure oil from the rod side of the arm hydraulic cylinder 12, and consequently, permits the crowd of the arm 9.

The excavator includes a hydraulic system that drives multiple hydraulic actuators (specifically, left and right travel hydraulic motors, swing hydraulic motor 3, boom hydraulic cylinder 11, arm hydraulic cylinder 12, and bucket hydraulic cylinder 13). FIG. 2 is a diagram showing the configuration of the hydraulic system in this embodiment, related to the driving of the swing hydraulic motor 3, boom hydraulic cylinder 11, arm hydraulic cylinder 12, and bucket hydraulic cylinder 13.

In this embodiment, the hydraulic system includes a prime mover 20 such as an engine, main pumps 21a, 21b, 21c driven by the prime mover 20, pressure sensors (discharge pressure sensors) 22a, 22b, 22c for detecting the discharge pressure of the main pumps 21a, 21b, 21c respectively, regulators 23a, 23b, 23c for controlling the discharge capacity (e.g., tilt angle of the pump swash plate) of the main pumps 21a, 21b, 21c respectively, a swing control valve 24 for controlling the flow of pressure oil from the main pump 21c to the swing hydraulic motor 3 (specifically, direction and flow rate; similarly hereafter), boom control valves 25a, 25b, 25c for controlling the flow of pressure oil from the main pumps 21a, 21b, 21c to the boom hydraulic cylinder 11 respectively, arm control valves 26a, 26b for controlling the flow of pressure oil from the main pumps 21a, 21b to the arm hydraulic cylinder 12 respectively, and a bucket control valve 27 for controlling the flow of pressure oil from the main pump 21a to the bucket hydraulic cylinder 13.

The hydraulic system includes a swing pilot solenoid valve 28a for generating and outputting right swing pilot pressure to operate the swing control valve 24, a swing pilot solenoid valve 28b for generating and outputting left swing pilot pressure to operate the swing control valve 24, a boom pilot solenoid valve 29a for generating and outputting boom lowering pilot pressure to operate the boom control valves 25a, 25b, a boom pilot solenoid valve 29b for generating and outputting boom raising pilot pressure to operate the boom control valves 25a, 25b, a boom pilot solenoid valve 29c for generating and outputting boom lowering pilot pressure to operate the boom control valve 25c, and a boom pilot solenoid valve 29d for generating and outputting boom raising pilot pressure to operate the boom control valve 25c.

The hydraulic system includes an arm pilot solenoid valve 30a for generating and outputting arm dump pilot pressure to operate the arm control valve 26a, an arm pilot solenoid valve 30b for generating and outputting arm crowd pilot pressure to operate the arm control valve 26a, an arm pilot solenoid valve 30c for generating and outputting arm dump pilot pressure to operate the arm control valve 26b, an arm pilot solenoid valve 30d for generating and outputting arm crowd pilot pressure to operate the arm control valve 26b, a bucket pilot solenoid valve 31a for generating and outputting bucket crowd pilot pressure to operate the bucket control valve 27, and a bucket pilot solenoid valve 31b for generating and outputting bucket dump pilot pressure to operate the bucket control valve 27.

The hydraulic system includes a boom solenoid valve 32 for generating and outputting release pressure to release the anti-drop function of the boom anti-drop valve 15, an arm solenoid valve 33 for generating and outputting release pressure to release the anti-drop function of the arm anti-drop valve 16, a controller 34, and operation devices 35a, 35b.

The pilot solenoid valves 28a, 28b, 29a-29d, 30a-30d, 31a, 31b generate pilot pressure using the discharge pressure of the pilot pump 36 driven by the prime mover 20 as the base pressure. A lock valve 37 is provided in the oil passage between the pilot solenoid valves 28a, 28b, 29a-29d, 30a-30d, 31a, 31b and the pilot pump 36. The lock valve 37 is switched between a communication state and a shut-off state in response to the operation of a lock lever (not shown) arranged in the operating room 17 of the swing body 2 shown in FIG. 1 above.

The operation devices 35a, 35b are arranged within the operating room 17 of the swing body 2. The operation device 35a includes an operation lever 38a that can be operated by the operator in the longitudinal and lateral directions, a first potentiometer (not shown) that outputs an operation signal corresponding to the forward operation amount of the operation lever 38a, a second potentiometer (not shown) that outputs an operation signal corresponding to the backward operation amount of the operation lever 38a, a third potentiometer (not shown) that outputs an operation signal corresponding to the left operation amount of the operation lever 38a, and a fourth potentiometer (not shown) that outputs an operation signal corresponding to the right operation amount of the operation lever 38a.

The operation device 35b includes an operation lever 38b that can be operated by the operator in the longitudinal and lateral directions, a fifth potentiometer (not shown) that outputs an operation signal corresponding to the forward operation amount of the operation lever 38b, a sixth potentiometer (not shown) that outputs an operation signal corresponding to the backward operation amount of the operation lever 38b, a seventh potentiometer (not shown) that outputs an operation signal corresponding to the left operation amount of the operation lever 38b, and an eighth potentiometer (not shown) that outputs an operation signal corresponding to the right operation amount of the operation lever 38b.

The controller 34 operates the corresponding pilot solenoid valve in response to the operation signals from the operation devices 35a, 35b. This switches the corresponding control valve and drives the corresponding hydraulic actuator. The details will be explained.

The controller 34 operates the swing pilot solenoid valve 28a in response to the operation signal from the first potentiometer (i.e., the forward operation amount of the operation lever 38a), and operates the swing pilot solenoid valve 28b in response to the operation signal from the second potentiometer (i.e., the backward operation amount of the operation lever 38a). This switches the swing control valve 24 and supplies pressure oil from the main pump 21c to one side or the other side of the swing hydraulic motor 3 via the swing control valve 24. This causes the swing hydraulic motor 3 to rotate in one direction or the opposite direction. As a result, the swing body 2 swings right or left.

The controller 34 operates at least one of the arm pilot solenoid valves 30a, 30c in response to the operation signal from the third potentiometer (i.e., the left operation amount of the operation lever 38a), and operates at least one of the arm pilot solenoid valves 30b, 30d in response to the operation signal from the fourth potentiometer (i.e., the right operation amount of the operation lever 38a). This switches at least one of the arm control valves 26a, 26b and supplies pressure oil from at least one of the main pumps 21a, 21b to the rod side or bottom side of the arm hydraulic cylinder 12 via the arm control valve. This causes the arm hydraulic cylinder 12 to compress or extend. As a result, the arm 9 dumps or crowds.

The controller 34 operates at least one of the boom pilot solenoid valves 29a, 29c in response to the operation signal from the fifth potentiometer (i.e., the forward operation amount of the operation lever 38b), and operates at least one of the boom pilot solenoid valves 29b, 29d in response to the operation signal from the sixth potentiometer (i.e., the backward operation amount of the operation lever 38b). This switches at least one of the boom control valves 25a, 25b and the boom control valve 25c and supplies pressure oil from at least one of the main pumps 21a, 21b and the main pump 21c to the rod side or bottom side of the boom hydraulic cylinder 11 via the boom control valve. This causes the boom hydraulic cylinder 11 to compress or extend. As a result, the boom 8 lowers or raises.

The controller 34 operates the bucket pilot solenoid valve 31a in response to the operation signal from the seventh potentiometer (i.e., the left operation amount of the operation lever 38b), and operates the bucket pilot solenoid valve 31b in response to the operation signal from the sixth potentiometer (i.e., the right operation amount of the operation lever 38b). This switches the bucket control valve 27 and supplies pressure oil from the main pump 21a to the bottom side or rod side of the bucket hydraulic cylinder 13 via the bucket control valve 27. This causes the bucket hydraulic cylinder 13 to extend or compress. As a result, the bucket 10 crowds or dumps.

When the operator intends to lower the boom 8 and operates the operation device 35b (i.e., when the operation signal from the fifth potentiometer is input), the controller 34 controls the boom solenoid valve 32, generates a release pressure, and outputs it to the boom anti-drop valve 15. This releases the anti-drop function of the boom anti-drop valve 15. That is, it allows the discharge of pressure oil from the bottom side of the boom hydraulic cylinder 11, and thus allows the lowering of the boom 8.

When the operator intends to crowd the arm 9 and operates the operation device 35a (i.e., when the operation signal from the fourth potentiometer is input), the controller 34 controls the arm solenoid valve 33, generates a release pressure, and outputs it to the arm anti-drop valve 16. This releases the anti-drop function of the arm anti-drop valve 16. That is, it allows the discharge of pressure oil from the rod side of the arm hydraulic cylinder 12, and thus allows the crowd of the arm 9.

The controller 34 has a limiting function that restricts the operation of the work device 7 to a predetermined range. The limiting function, for example, controls the pilot solenoid valve so that the reference point set on the bucket 10 (e.g., the tip of the bucket's toe) moves along a predetermined target surface when the operator intends to dump or crowd the arm 9 and operates the operation device 35a (movement trace control function).

The most significant feature of this embodiment is that the controller 34 releases the anti-drop function of the anti-drop valves 15, 16 by controlling the solenoid valves 32, 33 based not only on the operation status of the operation device but also on the distance between the reference point of the bucket 10 and the target surface, which is information related to the aforementioned limiting function. Specifically, based on the distance between the reference point of the bucket 10 and the target surface, the release pressure of the anti-drop valves 15, 16 is calculated, and the solenoid valves 32, 33 are controlled to output the calculated release pressure, which serves as a signal to release the anti-drop function, to the anti-drop valves 15, 16.

Next, the details of the controller 34 of this embodiment will be described. FIG. 3 is a block diagram illustrating the physical configuration of the controller in this embodiment along with related equipment. FIG. 4 is a block diagram illustrating the functional configuration of the controller in this embodiment along with related equipment.

The controller 34 is physically configured as at least one computer having non-volatile memory 40, volatile memory 41, a processing unit 42, an input interface 43, an output interface 44, and other peripheral circuits.

The non-volatile memory 40 may be, for example, a ROM (Read Only Memory), flash memory, or hard disk drive, and stores programs executable for various calculations and various data such as thresholds. The volatile memory 41 may be, for example, RAM (Random Access Memory), and temporarily stores the calculation results by the processing unit 42 and the signals input from the input interface 43.

The processing unit 42 may be, for example, a CPU (Central Processing Unit), MPU (Micro Processing Unit), DSP (Digital Signal Processor), ASIC (Application Specific Integrated Circuit), or FPGA (Field Programmable Gate Array). The processing unit 42 is a device that expands the program stored in the non-volatile memory 40 into the volatile memory 41 and executes calculations, performing predetermined processing on the data taken in from the input interface 43, non-volatile memory 40, and volatile memory 41 according to the program.

The input interface 43 converts signals input from various devices (angle sensors 4a to 4d, vehicle body position detection device 6, pressure sensors 14a to 14f, 22a to 22c, operation devices 35a, 35b, and target surface input device 45) into data that can be calculated by the processing unit 42. The output interface 44 generates output signals corresponding to the calculation results by the processing unit 42 and outputs those signals to various devices (regulators 23a to 23c, pilot solenoid valves 28a, 28b, 29a to 29d, 30a to 30d, 31a, 31b, solenoid valves 32, 33, and display device 46).

The target surface input device 45 is a device capable of inputting information regarding the target surface (in this embodiment, the excavation target surface).

For example, the three-dimensional data of the target surface in the global coordinate system can be input from an external terminal (not shown). Alternatively, for example, the position of the target surface and the inclination angle φ of the target surface with respect to the horizontal plane can be input manually by the operator. The display device 46 is, for example, a touch panel type liquid crystal monitor, and is arranged in the operating room 17 of the swing body 2.

The controller 34 has, as a functional configuration, a target surface position calculation unit 50, an attachment position calculation unit 51, a display control unit 52, a pilot pressure calculation unit 53, a target speed calculation unit 54, a pilot solenoid valve control unit 55, a regulator control unit 56, and a solenoid valve control unit 57.

The target surface position calculation unit 50 of the controller 34 calculates the position of the target surface St in the excavator coordinate system (local coordinate system) shown in FIG. 5, based on information from the target surface input device 45. The origin of the excavator coordinate system is set on the rotation center axis of the boom 8. The Z-axis of the excavator coordinate system is set to be parallel to the rotation center axis of the swing body 2, and the X-axis is set to be in the forward direction of the swing body 2 and perpendicular to the rotation center axis of the swing body 2. The target surface position calculation unit 50, for example, cuts the three-dimensional data of the target surface obtained from the target surface input device 45 with a vertical plane obtained based on the position and orientation of the vehicle body detected by the vehicle body position detection device 6 (specifically, a vertical plane extending in the operating direction of the work device 7), and calculates the position of the target surface St on the cut surface.

The attachment position calculation unit 51 of the controller 34 calculates the position of the reference point E of the bucket 10 in the excavator coordinate system based on the inclination angle θ of the vehicle body detected by the angle sensors 4a to 4d, the rotation angle α of the boom 8, the rotation angle β of the arm 9, and the rotation angle γ of the bucket 10, as well as the dimension information of the work device 7 stored in advance (specifically, the length L1 of the boom 8, the length L2 of the arm 9, and the length L2 of the bucket 10). Then, based on the calculated position of the reference point E of the bucket 10 and the position of the target surface St calculated by the target surface position calculation unit 50, the distance H between the reference point E of the bucket 10 and the target surface St (hereinafter referred to as the target surface distance H) is calculated.

The display control unit 52 of the controller 34 generates a screen 58 (see FIG. 6) representing the positional relationship based on the position of the target surface St calculated by the target surface position calculation unit 50 and the position of the reference point E of the bucket 10 calculated by the attachment position calculation unit 51, and displays it on the display device 46.

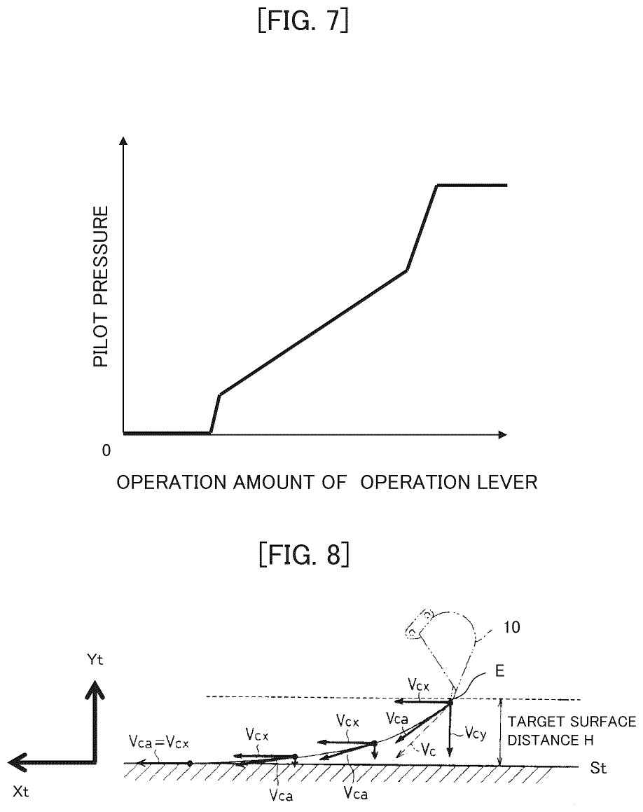

The pilot pressure calculation unit 53 of the controller 34 uses, for example, the correlation table shown in FIG. 7 to calculate the right swing pilot pressure or left swing pilot pressure corresponding to the operation signal from the first or second potentiometer (i.e., the operation amount of the front or rear side of the operation lever 38a). Also, for example, using the correlation table shown in FIG. 7, the arm dump pilot pressure or arm crowd pilot pressure corresponding to the operation signal from the third or fourth potentiometer (i.e., the operation amount of the left or right side of the operation lever 38a) is calculated. Also, for example, using the correlation table shown in FIG. 7, the boom lowering pilot pressure or boom raising pilot pressure corresponding to the operation signal from the fifth or sixth potentiometer (i.e., the operation amount of the front or rear side of the operation lever 38b) is calculated. Also, for example, using the correlation table shown in FIG. 7, the bucket crowd pilot pressure or bucket dump pilot pressure corresponding to the operation signal from the seventh or eighth potentiometer (i.e., the operation amount of the left or right side of the operation lever 38b) is calculated.

The target speed calculation unit 54 of the controller 34 calculates the target speed of the hydraulic cylinders 11, 12, 13 so that the reference point E of the bucket 10 does not move below the target surface St when the reference point E of the bucket 10 is located above the target surface St, as shown in FIG. 8. The Xt axis shown in FIG. 8 is an axis parallel to the target surface St, and the Yt axis shown in FIG. 8 is an axis perpendicular to the target surface St.

In detail, the target speed calculation unit 54 calculates the primary target speed of the boom hydraulic cylinder 11 based on the boom lowering pilot pressure or boom raising pilot pressure (primary pilot pressure) calculated by the pilot pressure calculation unit 53. Also, based on the arm dump pilot pressure or arm crowd pilot pressure (primary pilot pressure) calculated by the pilot pressure calculation unit 53, the primary target speed of the arm hydraulic cylinder 12 is calculated. Also, based on the bucket crowd pilot pressure or bucket dump pilot pressure (primary pilot pressure) calculated by the pilot pressure calculation unit 53, the primary target speed of the bucket hydraulic cylinder 13 is calculated. Then, based on the calculated primary target speeds of the hydraulic cylinders 11, 12, 13, the position of the reference point E of the bucket 10 calculated by the attachment position calculation unit 51, and the dimension information of the work device 7, the primary target speed vector Vc of the reference point E of the bucket 10 is calculated. Then, as the target surface distance H calculated by the attachment position calculation unit 51 approaches zero, the primary target speed of the necessary hydraulic cylinders among the hydraulic cylinders 11, 12, 13 is corrected so that the Yt-axis direction component Vcy of the primary target speed vector Vc approaches zero, resulting in a secondary target speed. As a result, the primary target speed vector Vc is converted into the secondary target speed vector Vca.

The target speed calculation unit 54 of the controller 34 calculates the target speed of the hydraulic cylinders 11, 12, 13 so that the reference point E of the bucket 10 moves along the target surface St when the reference point E of the bucket 10 is located on the target surface St.

In detail, the target speed calculation unit 54 calculates the secondary target speed of the boom hydraulic cylinder 11 in the boom raising direction to cancel the downward component when the primary target speed vector Vc includes a downward component (specifically, a component where the reference point E of the bucket 10 moves below the target surface St beyond the target surface St) accompanying the dump or crowd of the arm 9. Also, for example, when the primary target speed vector Vc includes an upward component (specifically, a component where the reference point E of the bucket 10 moves away from the target surface St) accompanying the dump or crowd of the arm 9, the secondary target speed of the boom hydraulic cylinder 11 in the boom lowering direction to cancel the upward component is calculated.

The pilot solenoid valve control unit 55 of the controller 34 controls the swing pilot solenoid valve to generate the right swing pilot pressure or left swing pilot pressure calculated by the pilot pressure calculation unit 53.

The pilot solenoid valve control unit 55 of the controller 34 calculates the target flow rate of the pressure oil passing through each of the boom control valves 25a to 25c based on the target speed of the boom hydraulic cylinder 11 calculated by the target speed calculation unit 54. Also, based on the detection results of the pressure sensors 14a, 14b, 22a to 22c, the differential pressure before and after each of the boom control valves 25a to 25c is calculated. Then, based on the target flow rate and differential pressure of the boom control valves 25a to 25c, the boom lowering pilot pressure or boom raising pilot pressure (secondary pilot pressure) for operating the boom control valves 25a to 25c is calculated. Then, the boom pilot solenoid valve is controlled to generate the calculated boom lowering pilot pressure or boom raising pilot pressure.

The pilot solenoid valve control unit 55 of the controller 34 calculates the target flow rate of the pressure oil passing through each of the arm control valves 26a, 26b based on the target speed of the arm hydraulic cylinder 12 calculated by the target speed calculation unit 54. Also, based on the detection results of the pressure sensors 14c, 14d, 22a, 22b, the differential pressure before and after each of the arm control valves 26a, 26b is calculated. Then, based on the target flow rate and differential pressure of the arm control valves 26a, 26b, the arm dump pilot pressure or arm crowd pilot pressure (secondary pilot pressure) for operating the arm control valves 26a, 26b is calculated. Then, the arm pilot solenoid valve is controlled to generate the calculated arm dump pilot pressure or arm crowd pilot pressure.

The pilot solenoid valve control unit 55 of the controller 34 calculates the target flow rate of the pressure oil passing through the bucket control valve 27 based on the target speed of the bucket hydraulic cylinder 13 calculated by the target speed calculation unit 54. Also, based on the detection results of the pressure sensors 14e, 14f, 22a, the differential pressure before and after the bucket control valve 27 is calculated. Then, based on the target flow rate and differential pressure of the bucket control valve 27, the bucket crowd pilot pressure or bucket dump pilot pressure (secondary pilot pressure) for operating the bucket control valve 27 is calculated. Then, the bucket pilot solenoid valve is controlled to generate the calculated bucket crowd pilot pressure or bucket dump pilot pressure.

The regulator control unit 56 of the controller 34 calculates the target flow rate of pressure oil passing through the swing control valve 24 based on the pilot pressure for right swing or left swing calculated by the pilot pressure calculation unit 53. Then, based on the target flow rate of pressure oil passing through control valves 24, 25a to 25c, 26a, 26b, and 27, the target flow rate of main pumps 21a to 21c is calculated. Then, regulators 23a to 23c are controlled to achieve the discharge capacity of main pumps 21a to 21c to obtain the calculated target flow rate.

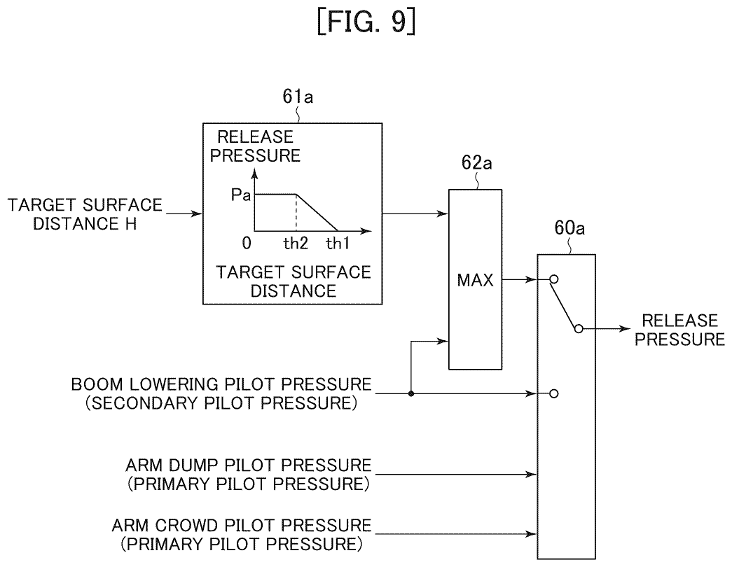

The solenoid valve control unit 57 of the controller 34 sets the release pressure of the boom solenoid valve 32 based on the boom lowering pilot pressure calculated by the pilot solenoid valve control unit 55 and the target surface distance H calculated by the attachment position calculation unit 51. The details are explained using FIG. 9. FIG. 9 is a diagram representing the process of setting the release pressure of the boom solenoid valve in this embodiment.

The release pressure setting unit 60a of the solenoid valve control unit 57 determines whether one of the arm dump pilot pressure and arm crowd pilot pressure (primary pilot pressure) calculated by the pilot pressure calculation unit 53 is greater than zero (in other words, whether the left or right operation amount of the operation lever 38a exceeds a predetermined threshold) as one of the conditions for possible automatic control of boom lowering. If both the arm dump pilot pressure and arm crowd pilot pressure are zero (i.e., automatic control of boom lowering is not performed), the release pressure setting unit 60a sets the release pressure corresponding to the boom lowering pilot pressure (secondary pilot pressure) calculated by the pilot solenoid valve control unit 55.

On the other hand, if one of the arm dump pilot pressure and arm crowd pilot pressure calculated by the pilot pressure calculation unit 53 is greater than zero (i.e., there is a possibility of automatic control of boom lowering), the release pressure setting unit 60a sets the release pressure obtained by the release pressure calculation unit 61a and the selection unit 62a. The release pressure calculation unit 61a calculates the first release pressure that changes according to the target surface distance H. Specifically, if the target surface distance H is equal to or greater than a predetermined threshold th1, the first release pressure is set to zero, and if the target surface distance H is equal to or less than a predetermined threshold th2, the first release pressure is set to a predetermined value Pa. The selection unit 62a selects the larger of the first release pressure calculated by the release pressure calculation unit 61a and the second release pressure corresponding to the boom lowering pilot pressure calculated by the pilot solenoid valve control unit 55. The release pressure setting unit 60a sets the release pressure selected by the selection unit 62a. Therefore, when the conditions including the target surface distance H are met, the release pressure is set to a predetermined value Pa or higher.

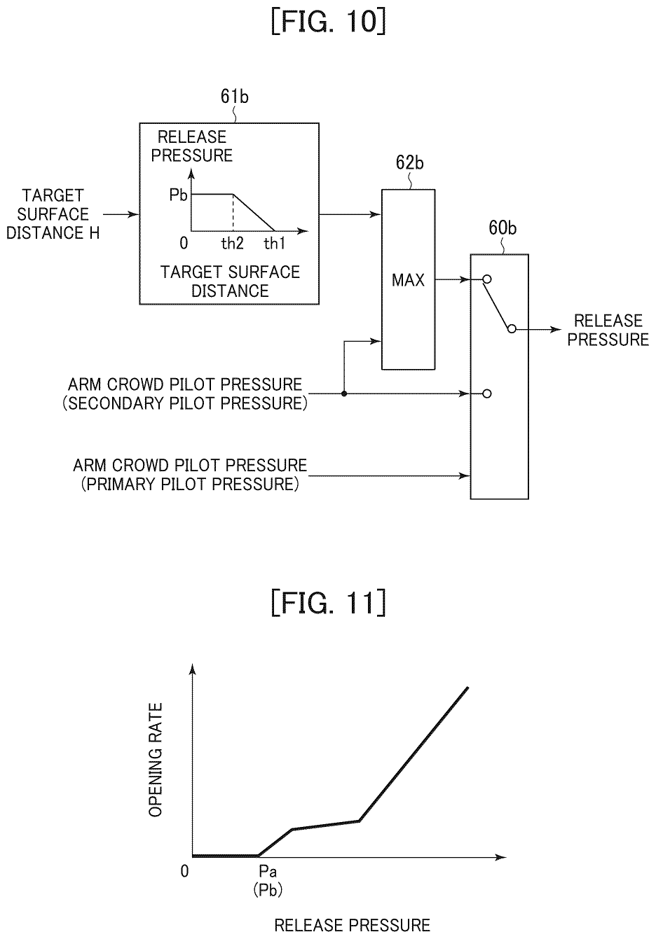

The solenoid valve control unit 57 of the controller 34 sets the release pressure of the arm solenoid valve 33 based on the arm crowd pilot pressure calculated by the pilot solenoid valve control unit 55 and the target surface distance H calculated by the attachment position calculation unit 51. The details are explained using FIG. 10. FIG. 10 is a diagram representing the process of setting the release pressure of the arm solenoid valve in this embodiment.

The release pressure setting unit 60b of the solenoid valve control unit 57 determines whether the arm crowd pilot pressure (primary pilot pressure) calculated by the pilot pressure calculation unit 53 is greater than zero (in other words, whether the right operation amount of the operation lever 38a exceeds a predetermined threshold) as one of the conditions for possible automatic control of arm crowd. If the arm crowd pilot pressure (primary pilot pressure) is zero (i.e., automatic control of arm crowd is not performed), the release pressure setting unit 60b sets the release pressure corresponding to the arm crowd pilot pressure (secondary pilot pressure) calculated by the pilot solenoid valve control unit 55.

On the other hand, if the arm crowd pilot pressure calculated by the pilot pressure calculation unit 53 is greater than zero (i.e., there is a possibility of automatic control of arm crowd), the release pressure setting unit 60b sets the release pressure obtained by the release pressure calculation unit 61b and the selection unit 62b. The release pressure calculation unit 61b calculates the third release pressure that changes according to the target surface distance H. Specifically, if the target surface distance H is equal to or greater than a predetermined threshold th1, the third release pressure is set to zero, and if the target surface distance H is equal to or less than a predetermined threshold th2, the third release pressure is set to a predetermined value Pb. The selection unit 62b selects the larger of the third release pressure calculated by the release pressure calculation unit 61b and the fourth release pressure corresponding to the arm crowd pilot pressure (secondary pilot pressure) calculated by the pilot solenoid valve control unit 55. The release pressure setting unit 60b sets the release pressure selected by the selection unit 62b. Therefore, when the conditions including the target surface distance H are met, the release pressure is set to a predetermined value Pb or higher.

The solenoid valve control unit 57 of the controller 34 controls the solenoid valves 32, 33 to generate the release pressure set as described above.

Here, the predetermined values Pa, Pb of the release pressure for the anti-drop valve are explained using FIG. 11. FIG. 11 is a diagram representing the relationship between the release pressure and the opening rate of the anti-drop valve in this embodiment. The predetermined values Pa, Pb of the release pressure for the anti-drop valve are the minimum release pressure required to open the anti-drop valve (in other words, to move the poppet valve body from the blocking position). The predetermined values Pa, Pb vary due to the solid differences of the anti-drop valve, and it is preferable that they are set by the learning function of the controller 34 or the like.

As described above, in this embodiment, when the target surface distance H is equal to or less than a predetermined threshold, the solenoid valves 32, 33 are controlled to output the release pressure to the anti-drop valves 15, 16, thereby releasing the anti-drop function of the anti-drop valves 15, 16. This allows the avoidance of the impact of solid differences in the anti-drop valves 15, 16, and improves the accuracy of movement trace control by ensuring that the start timing of boom lowering and bucket crowd does not lag behind the target value.

In the first embodiment, the release pressure setting unit 60a of the solenoid valve control unit 57 of the controller 34 was explained using the example of determining whether one of the arm dump pilot pressure and arm crowd pilot pressure calculated by the pilot pressure calculation unit 53 is greater than zero as one of the conditions for possible automatic control of boom lowering, but it is not limited to this.

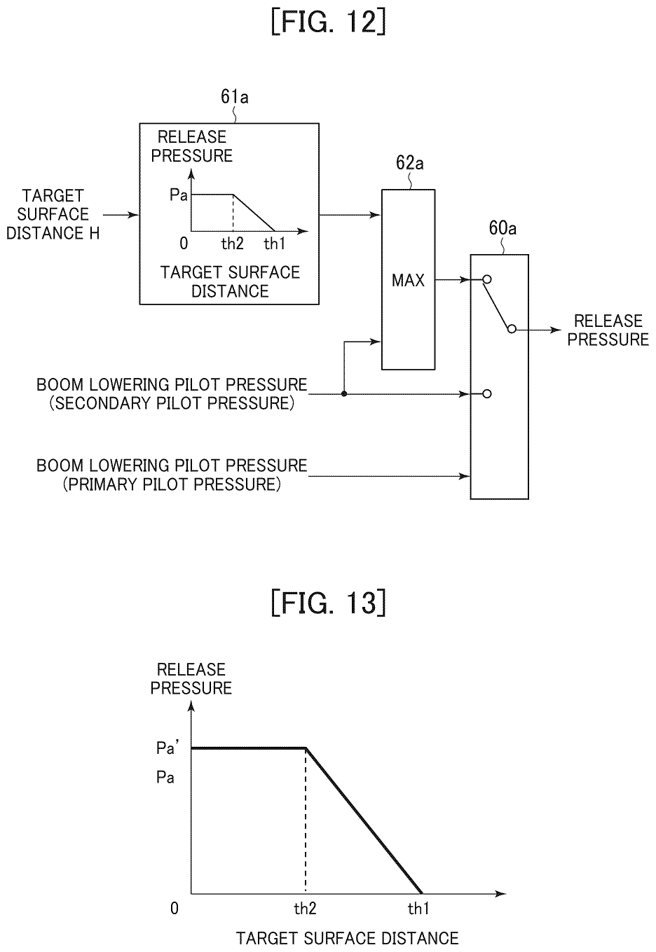

As shown in the modification example in FIG. 12, the release pressure setting unit 60a of the solenoid valve control unit 57 may determine whether the boom lowering pilot pressure (primary pilot pressure) calculated by the pilot pressure calculation unit 53 is greater than zero (in other words, whether the front operation amount of the operation lever 38b exceeds a predetermined threshold) as another condition for possible automatic control of boom lowering. If the boom lowering pilot pressure (primary pilot pressure) is zero, the release pressure setting unit 60a sets the release pressure corresponding to the boom lowering pilot pressure (secondary pilot pressure) calculated by the pilot solenoid valve control unit 55. On the other hand, if the boom lowering pilot pressure (primary pilot pressure) is greater than zero, the release pressure setting unit 60a sets the release pressure obtained by the release pressure calculation unit 61a and the selection unit 62a.

In the above embodiment and modification example, the release pressure calculation unit 61a (or 61b) of the solenoid valve control unit 57 of the controller 34 was explained using the example of setting the release pressure to zero if the target surface distance H is equal to or greater than a predetermined threshold th1, and setting the release pressure to a predetermined value Pa (or Pb) if the target surface distance H is equal to or less than a predetermined threshold th2, but it is not limited to this.

As shown in the modification example in FIG. 13, the release pressure calculation unit 61a (or 61b) may set the release pressure to zero if the target surface distance H is equal to or greater than a predetermined threshold th1, and set the release pressure to a predetermined value Pa′ (or Pb′) if the target surface distance H is equal to or less than a predetermined threshold th2. The predetermined value Pa′ or Pb′ is, for example, about 0.05 to 0.2 MPa larger than the predetermined value Pa or Pb (the minimum release pressure required to open the anti-drop valve).

Also, as shown in the modification example in FIG. 14, the release pressure calculation unit 61a (or 61b) may set the release pressure to zero if the target surface distance H is equal to or greater than a predetermined threshold th1, set the release pressure to a predetermined value Pa′ (or Pb′) if the target surface distance H is between a predetermined threshold th2 and a predetermined threshold th3, and set the release pressure to a predetermined value Pa (or Pb) if the target surface distance H is zero. Furthermore, if the target surface distance H becomes negative (in other words, if the reference point of the bucket 10 moves beyond the target surface to the lower side of the target surface), the release pressure may be reduced from the predetermined value Pa (or Pb) according to the negative value.

In the first embodiment, the release pressure calculation unit 61a of the solenoid valve control unit 57 of the controller 34 was explained using the example of calculating the first release pressure that changes according to the target surface distance H, but it is not limited to this.

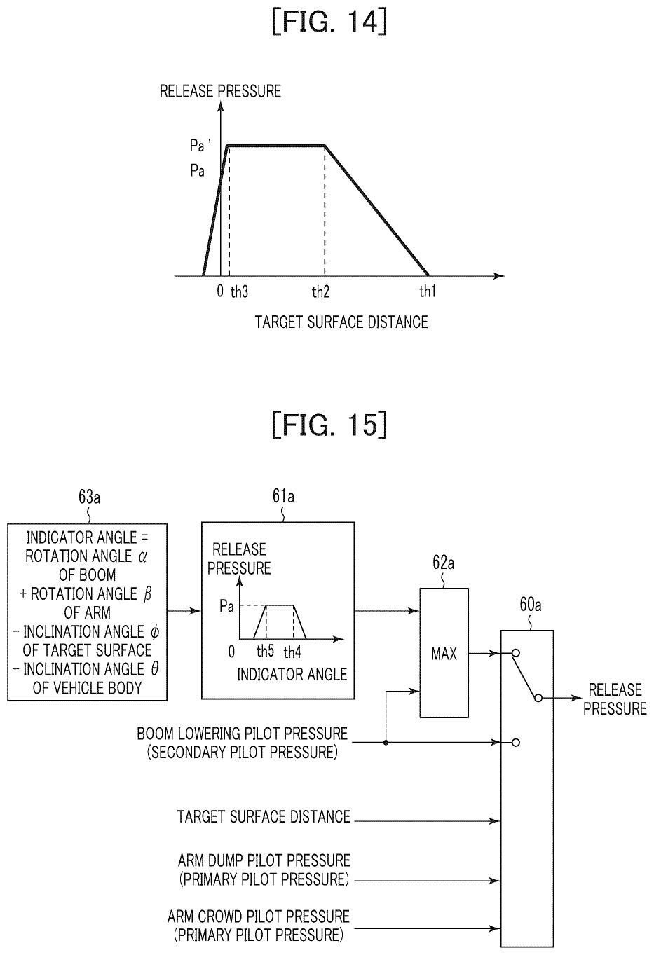

As shown in the modification example in FIG. 15, the release pressure setting unit 60a of the solenoid valve control unit 57 determines whether one of the pilot pressures calculated by the pilot pressure calculation unit 53 for arm dump and arm crowd (primary pilot pressure) is greater than zero (in other words, whether the left or right operation amount of the operation lever 38a exceeds a predetermined threshold) as one of the conditions that may enable automatic control of boom lowering. Another condition that may enable automatic control of boom lowering is determining whether the target surface distance H calculated by the attachment position calculation unit 51 is below a predetermined threshold. If both the arm dump pilot pressure and arm crowd pilot pressure are zero, or if the target surface distance H exceeds the predetermined threshold (i.e., when automatic control of boom lowering is not performed), the release pressure setting unit 60a sets the release pressure corresponding to the boom lowering pilot pressure (secondary pilot pressure) calculated by the pilot solenoid valve control unit 55.

On the other hand, if one of the arm dump pilot pressure and arm crowd pilot pressure calculated by the pilot pressure calculation unit 53 is greater than zero, and the target surface distance H is below the predetermined threshold (i.e., when automatic control of boom lowering may be performed), the release pressure setting unit 60a sets the release pressure obtained by the indicator angle calculation unit 63a, release pressure calculation unit 61a, and selection unit 62a. The indicator angle calculation unit 63a calculates the indicator angle (=the rotation angle α of the boom 8+the rotation angle β of the arm 9+the inclination angle θ of the vehicle body−the inclination angle φ of the inclined surface). The release pressure calculation unit 61a calculates the first release pressure that varies according to the indicator angle. Specifically, if the indicator angle is between threshold th4 and threshold th5 (where thresholds th4 and th5 are values set around 90 degrees), the first release pressure is set to a predetermined value Pa. The selection unit 62a selects the larger of the first release pressure calculated by the release pressure calculation unit 61a and the second release pressure corresponding to the boom lowering pilot pressure calculated by the pilot solenoid valve control unit 55. The release pressure setting unit 60a sets the release pressure selected by the selection unit 62a.

In this modification example, similar effects to the first embodiment can be obtained. Additionally, compared to the first embodiment, the driving frequency of the boom solenoid valve 32 can be reduced.

The second embodiment of the present invention will be described with reference to the drawings. In this embodiment, parts equivalent to those in the first embodiment are denoted by the same reference numerals, and explanations are omitted as appropriate.

In this embodiment, the controller 34 has a restriction function to limit the operation of the work device 7 within a predetermined range, specifically a function (deviation prevention control function) to control the pilot solenoid valve so that the work device 7 does not deviate from a predetermined work area.

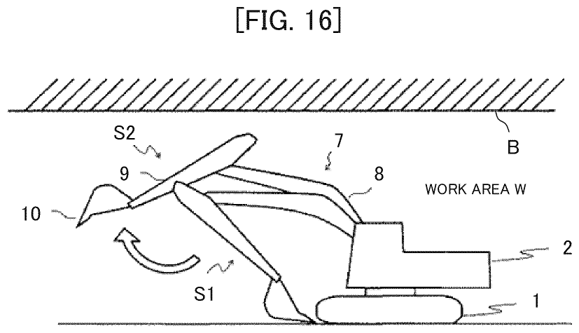

In detail, for example, as shown in FIG. 16, it is assumed that the operator operates the operation devices 35a, 35b intending to transition the posture of the work device 7 from posture S1 to posture S2. At this time, if the speed of raising the boom 8 is excessive, the upper part of the arm 9 may deviate from the work area W. Therefore, the controller 34 controls the boom pilot solenoid valve 29b to decelerate or stop the raising of the boom 8 (i.e., the extension of the boom hydraulic cylinder 11) according to the distance between the arm 9 and the boundary B of the work area. This makes it possible to prevent the work device 7 from deviating from the work area W.

The most significant feature of this embodiment is that the controller 34 controls the solenoid valves 32, 33 not only based on the operational status of the operation device but also on the distance between the work device 7 and the boundary B of the work area, which is information related to the aforementioned restriction function. This allows the anti-drop function of the anti-drop valves 15, 16 to be released. Specifically, based on the distance between the work device 7 and the boundary B of the work area, the release pressure of the anti-drop valves 15, 16 is calculated, and the calculated release pressure, which serves as a signal to release the anti-drop function, is output to the anti-drop valves 15, 16 by controlling the solenoid valves 32, 33.

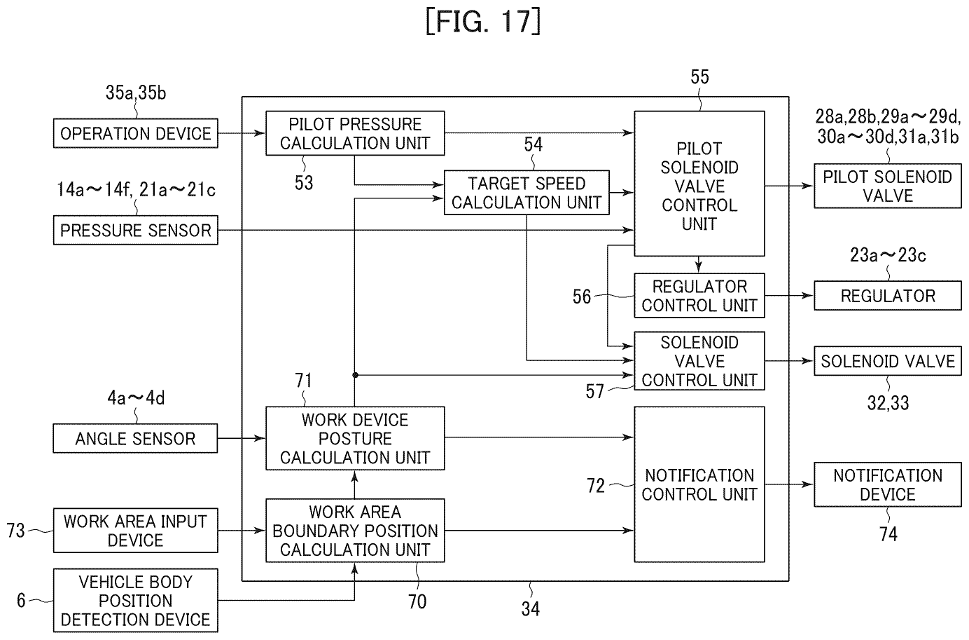

Next, the details of the controller 34 in this embodiment will be described. FIG. 17 is a block diagram representing the functional configuration of the controller in this embodiment along with related equipment.

The controller 34 has, as a functional configuration, a work area calculation unit 70, a work device posture calculation unit 71, a pilot pressure calculation unit 53, a target speed calculation unit 54, a pilot solenoid valve control unit 55, a regulator control unit 56, a solenoid valve control unit 57, and a notification control unit 72.

The work area calculation unit 70 of the controller 34 calculates the position of the boundary B of the work area in the excavator coordinate system based on information from the work area input device 73. The work area calculation unit 70, for example, cuts the three-dimensional data of the work area obtained from the work area input device 73 with a vertical plane obtained based on the position and direction of the vehicle body detected by the vehicle body position detection device 6 (specifically, a vertical plane extending in the operation direction of the work device 7) and calculates the position of the boundary B of the work area on the cut surface.

The work device posture calculation unit 71 of the controller 34 calculates the posture and position of the work device 7 (specifically, the boom 8, arm 9, and bucket 10) in the excavator coordinate system based on the inclination angle θ of the vehicle body, the rotation angle α of the boom 8, the rotation angle β of the arm 9, and the rotation angle γ of the bucket 10 detected by the angle sensors 4a to 4d, and the pre-stored dimension information of the work device 7 (specifically, the length L1 of the boom 8, the length L2 of the arm 9, and the length L2 of the bucket 10).

The target speed calculation unit 54 of the controller 34 calculates the target speed of the hydraulic cylinders 11, 12, 13 so that the work device 7 does not deviate from the work area W beyond the boundary B of the work area.

In detail, the target speed calculation unit 54 calculates the primary target speed of the boom hydraulic cylinder 11 based on the boom lowering pilot pressure or boom raising pilot pressure (primary pilot pressure) calculated by the pilot pressure calculation unit 53. Additionally, based on the arm dump pilot pressure or arm crowd pilot pressure (primary pilot pressure) calculated by the pilot pressure calculation unit 53, the primary target speed of the arm hydraulic cylinder 12 is calculated. Additionally, based on the bucket crowd pilot pressure or bucket dump pilot pressure (primary pilot pressure) calculated by the pilot pressure calculation unit 53, the primary target speed of the bucket hydraulic cylinder 13 is calculated.

The target speed calculation unit 54 calculates the stop angle αt of the boom 8, the stop angle βt of the arm 9, and the stop angle γt of the bucket 10 based on the posture and position of the work device 7 calculated by the work device posture calculation unit 71 and the position of the boundary B of the work area calculated by the work area calculation unit 70. The stop angle αt of the boom 8 is the rotation angle of the boom 8 when the work device 7 reaches the boundary B of the work area by rotating only the boom 8, based on the current posture and position of the work device 7. The stop angle βt of the arm 9 is the rotation angle of the arm 9 when the work device 7 reaches the boundary B of the work area by rotating only the arm 9, based on the current posture and position of the work device 7. The stop angle γt of the bucket 10 is the rotation angle of the bucket 10 when the work device 7 reaches the boundary B of the work area by rotating only the bucket 10, based on the current posture and position of the work device 7.

The target speed calculation unit 54 calculates the difference Δα between the rotation angle α of the boom 8 detected by the angle sensor 4b and the stop angle αt. Then, according to the difference Δα, the target speed calculation unit 54 calculates the limit speed (angular velocity) of the boom 8 to decelerate or stop the operation of the boom 8, and converts this to the limit speed of the boom hydraulic cylinder 11. Additionally, the target speed calculation unit 54 calculates the difference Δβ between the rotation angle β of the arm 9 detected by the angle sensor 4c and the stop angle βt. Then, according to the difference Δβ, the target speed calculation unit 54 calculates the limit speed (angular velocity) of the arm 9 to decelerate or stop the operation of the arm 9, and converts this to the limit speed of the arm hydraulic cylinder 12. Additionally, the target speed calculation unit 54 calculates the difference Δγ between the rotation angle γ of the bucket 10 detected by the angle sensor 4d and the stop angle γt. Then, according to the difference Δγ, the target speed calculation unit 54 calculates the limit speed (angular velocity) of the bucket 10 to decelerate or stop the operation of the bucket 10, and converts this to the limit speed of the bucket hydraulic cylinder 13.

The target speed calculation unit 54 sets the primary target speed as the secondary target speed if the primary target speed of the boom hydraulic cylinder 11 is below the limit speed, and sets the limit speed as the secondary target speed if the primary target speed is at or above the limit speed. Similarly, if the primary target speed of the arm hydraulic cylinder 12 is below the limit speed, the primary target speed is set as the secondary target speed, and if the primary target speed is at or above the limit speed, the limit speed is set as the secondary target speed. Similarly, if the primary target speed of the bucket hydraulic cylinder 13 is below the limit speed, the primary target speed is set as the secondary target speed, and if the primary target speed is at or above the limit speed, the limit speed is set as the secondary target speed.

The notification control unit 72 of the controller 34 controls the notification device 74 to output work support information. The notification device 74 is configured as one or a combination of a monitor, speaker, and warning light. The work support information includes, for example, the presence or absence of deceleration by deviation prevention control, identification information of decelerated members (such as names, images), and the positional relationship between the work device 7 and the work area W or its boundary B.

The pilot solenoid valve control unit 55 of the controller 34 controls the swing pilot solenoid valve to generate the right or left swing pilot pressure calculated by the pilot pressure calculation unit 53.

The pilot solenoid valve control unit 55 of the controller 34 calculates the target flow rate of pressure oil passing through each of the boom control valves 25a to 25c based on the secondary target speed of the boom hydraulic cylinder 11 calculated by the target speed calculation unit 54. Additionally, it calculates the differential pressure before and after each of the boom control valves 25a to 25c based on the detection results of pressure sensors 14a, 14b, 22a to 22c. Then, it calculates the boom lowering pilot pressure or boom raising pilot pressure (secondary pilot pressure) to operate the boom control valves 25a to 25c based on the target flow rate and differential pressure of the boom control valves 25a to 25c. Then, it controls the boom pilot solenoid valve to generate the calculated boom lowering pilot pressure or boom raising pilot pressure.

The pilot solenoid valve control unit 55 of the controller 34 calculates the target flow rate of pressure oil passing through each of the arm control valves 26a, 26b based on the secondary target speed of the arm hydraulic cylinder 12 calculated by the target speed calculation unit 54. Additionally, it calculates the differential pressure before and after each of the arm control valves 26a, 26b based on the detection results of pressure sensors 14c, 14d, 22a, 22b. Then, it calculates the arm dump pilot pressure or arm crowd pilot pressure (secondary pilot pressure) to operate the arm control valves 26a, 26b based on the target flow rate and differential pressure of the arm control valves 26a, 26b. Then, it controls the arm pilot solenoid valve to generate the calculated arm dump pilot pressure or arm crowd pilot pressure.

The pilot solenoid valve control unit 55 of the controller 34 calculates the target flow rate of pressure oil passing through the bucket control valve 27 based on the secondary target speed of the bucket hydraulic cylinder 13 calculated by the target speed calculation unit 54. Additionally, it calculates the differential pressure before and after the bucket control valve 27 based on the detection results of pressure sensors 14e, 14f, 22a. Then, it calculates the bucket crowd pilot pressure or bucket dump pilot pressure (secondary pilot pressure) to operate the bucket control valve 27 based on the target flow rate and differential pressure of the bucket control valve 27. Then, it controls the bucket pilot solenoid valve to generate the calculated bucket crowd pilot pressure or bucket dump pilot pressure.

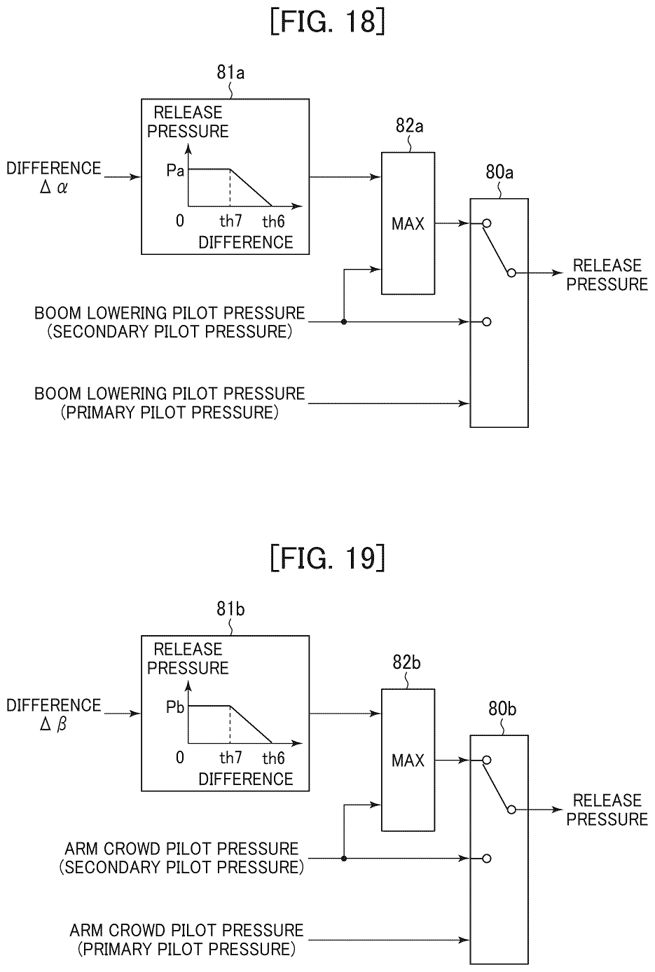

The solenoid valve control unit 57 of the controller 34 sets the release pressure of the boom solenoid valve 32 based on the boom lowering pilot pressure calculated by the pilot solenoid valve control unit 55 and the difference Da between the rotation angle α and the stop angle αt of the boom 8 calculated by the target speed calculation unit 54. The details will be explained using FIG. 18. FIG. 18 is a diagram illustrating the process of setting the release pressure of the boom solenoid valve in this embodiment.

The release pressure setting unit 80a of the solenoid valve control unit 57 determines whether the boom lowering pilot pressure (primary pilot pressure) calculated by the pilot pressure calculation unit 53 is greater than zero (in other words, whether the forward operation amount of the operation lever 38b exceeds a predetermined threshold) as one of the conditions for possibly performing speed restriction control for boom lowering. If the boom lowering pilot pressure (primary pilot pressure) is zero (i.e., speed restriction control for boom lowering is not performed), the release pressure setting unit 80a sets the release pressure corresponding to the boom lowering pilot pressure (secondary pilot pressure) calculated by the pilot solenoid valve control unit 55.

On the other hand, if the boom lowering pilot pressure calculated by the pilot pressure calculation unit 53 is greater than zero (i.e., there is a possibility of performing speed restriction control for boom lowering), the release pressure setting unit 80a sets the release pressure obtained by the release pressure calculation unit 81a and the selection unit 82a. The release pressure calculation unit 81a calculates the third release pressure that varies according to the difference Δα between the rotation angle α and the stop angle αt of the boom 8 (in other words, the distance between the work device 7 and the boundary B of the work area). Specifically, if the difference Δα is equal to or greater than a predetermined threshold th6, the third release pressure is set to zero, and if the difference Δα is equal to or less than a predetermined threshold th7, the third release pressure is set to a predetermined value Pa. The selection unit 82a selects the larger of the third release pressure calculated by the release pressure calculation unit 81a and the fourth release pressure corresponding to the boom pilot pressure (secondary pilot pressure) calculated by the pilot solenoid valve control unit 55. The release pressure setting unit 80a sets the release pressure selected by the selection unit 82a. Therefore, when the conditions including the difference Δβ between the rotation angle β and the stop angle βt of the arm 9 (in other words, the distance between the work device 7 and the boundary B of the work area) are met, the release pressure is set to a predetermined value Pb or higher.

The solenoid valve control unit 57 of the controller 34 sets the release pressure of the arm solenoid valve 33 based on the arm crowd pilot pressure calculated by the pilot solenoid valve control unit 55 and the difference Δβ between the rotation angle β and the stop angle βt of the arm 9 calculated by the target speed calculation unit 54. The details will be explained using FIG. 19. FIG. 19 is a diagram illustrating the process of setting the release pressure of the arm solenoid valve in this embodiment.

The release pressure setting unit 80b of the solenoid valve control unit 57 determines whether the arm crowd pilot pressure (primary pilot pressure) calculated by the pilot pressure calculation unit 53 is greater than zero (in other words, whether the right-side operation amount of the operation lever 38a exceeds a predetermined threshold) as one of the conditions for possibly performing speed restriction control for arm crowd. If the arm crowd pilot pressure (primary pilot pressure) is zero (i.e., speed restriction control for arm crowd is not performed), the release pressure setting unit 80b sets the release pressure corresponding to the arm crowd pilot pressure (secondary pilot pressure) calculated by the pilot solenoid valve control unit 55.

On the other hand, if the arm crowd pilot pressure calculated by the pilot pressure calculation unit 53 is greater than zero (i.e., there is a possibility of performing speed restriction control for arm crowd), the release pressure setting unit 80b sets the release pressure obtained by the release pressure calculation unit 81b and the selection unit 82b. The release pressure calculation unit 81b calculates the third release pressure that varies according to the difference Δβ between the rotation angle β and the stop angle βt of the arm 9 (in other words, the distance between the work device 7 and the boundary B of the work area). Specifically, if the difference Δβ is equal to or greater than a predetermined threshold th6, the third release pressure is set to zero, and if the difference Δβ is equal to or less than a predetermined threshold th7, the third release pressure is set to a predetermined value Pb. The selection unit 82b selects the larger of the third release pressure calculated by the release pressure calculation unit 81b and the fourth release pressure corresponding to the arm crowd pilot pressure (secondary pilot pressure) calculated by the pilot solenoid valve control unit 55. The release pressure setting unit 80b sets the release pressure selected by the selection unit 82b. Therefore, when the conditions including the difference Δβ between the rotation angle β and the stop angle βt of the arm 9 (in other words, the distance between the work device 7 and the boundary B of the work area) are met, the release pressure is set to a predetermined value Pb or higher.

The solenoid valve control unit 57 of the controller 34 controls the solenoid valves 32, 33 to generate the release pressure set as described above.

As described above, in this embodiment, when the distance between the work device 7 and the boundary B of the work area is below a predetermined threshold, the solenoid valves 32, 33 are controlled to output release pressure to the anti-drop valves 15, 16, thereby deactivating the anti-drop function of the anti-drop valves 15, 16. This avoids the influence of solid differences in the anti-drop valves 15, 16, preventing the timing of boom lowering or bucket crowd from being earlier than the target value, thereby improving the accuracy of deviation prevention control.

In the first embodiment, the release pressure calculation unit 81a (or 81b) of the solenoid valve control unit 57 of the controller 34 sets the release pressure to zero if the difference Δα (or Δβ) is equal to or greater than a predetermined threshold th6, and sets the release pressure to a predetermined value Pa (or Pb) if the difference Δα (or Δβ) is equal to or less than a predetermined threshold th7, as an example, but it is not limited to this.

As shown in the modification example in FIG. 20, the release pressure calculation unit 81a (or 81b) sets the release pressure to zero if the difference Δα (or Δβ) is equal to or greater than a predetermined threshold th6, and may set the release pressure to a predetermined value Pa′ (or Pb′) if the difference Δα (or Δβ) is equal to or less than a predetermined threshold th7.

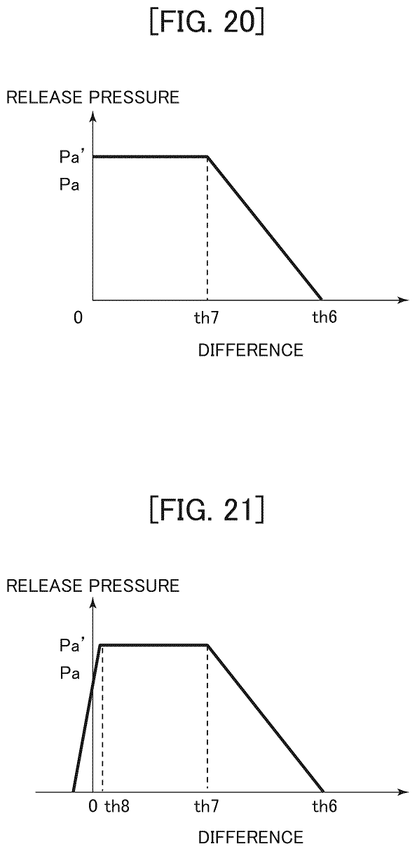

Furthermore, as shown in the modification example in FIG. 21, the release pressure calculation unit 81a (or 81b) sets the release pressure to zero if the difference Δα (or Δβ) is equal to or greater than a predetermined threshold th6, sets the release pressure to a predetermined value Pa′ (or Pb′) if the difference Δα (or Δβ) is between a predetermined threshold th7 and a predetermined threshold th8, and may set the release pressure to a predetermined value Pa (or Pb) if the difference Δα (or Δβ) is zero. Furthermore, if the difference Δα (or Δβ) becomes negative (in other words, if part of the work device 7 moves beyond the boundary B to the outside of the work area W), the release pressure may be reduced from the predetermined value Pa (or Pb) according to the negative value.

Although the above description uses an excavator as an example of the application of the present invention, it is not limited to this and may be applied to other work machines.

### DESCRIPTION OF REFERENCE CHARACTERS

7: Work device
8: Boom (connecting member)
9: Arm (connecting member)
10: Bucket (attachment)
11: Boom hydraulic cylinder
12: Arm hydraulic cylinder
15: Boom anti-drop valve
16: Arm anti-drop valve
25a-25c: Boom control valve
26a, 26b: Arm control valve
29a-29d: Boom pilot solenoid valve
30a-30d: Arm pilot solenoid valve
32: Boom solenoid valve
33: Arm solenoid valve
34: Controller

1. A work machine comprising:
an articulated work device having at least one connecting member that is capable of rotating in a vertical direction and an attachment;
a hydraulic cylinder for rotating the connecting member;
a control valve for controlling a flow of pressure oil to the hydraulic cylinder;
a plurality of pilot solenoid valves that generate pilot pressure to operate the control valve and output it to the control valve; and
a controller with a limiting function to control the plurality of pilot solenoid valves to restrict an operation of the work device within a predetermined range,
wherein the work machine further includes
an anti-drop valve with an anti-drop function to prevent a fall of the connecting member, and
a solenoid valve that outputs release pressure to release the anti-drop function to the anti-drop valve,
wherein the controller is configured to
calculate the release pressure of the anti-drop valve based on information related to the limiting function that controls the plurality of pilot solenoid valves, and
control the solenoid valve to output the calculated release pressure which serves as a signal to release the anti-drop function to the anti-drop valve.

2. The work machine according to claim 1,
wherein the limiting function is a function to control the plurality of pilot solenoid valves such that a reference point of the attachment moves along a predetermined target surface,
wherein the controller is configured to calculate a distance between the reference point of the attachment and the predetermined target surface as the information related to the limiting function, and based on the calculated distance between the reference point of the attachment and the predetermined target surface, calculate the release pressure and control the solenoid valve to output the calculated release pressure to the anti-drop valve.

3. The work machine according to claim 2,
wherein the controller is configured to select greater one of a release pressure that varies according to the distance between the reference point of the attachment and the predetermined target surface, and a release pressure corresponding to the pilot pressure of the pilot solenoid valve that rotates the connecting member downward, and control the solenoid valve to output the selected release pressure to the anti-drop valve.

4. The work machine according to claim 1,
wherein the limiting function is a function to control the plurality of pilot solenoid valves such that the work device does not deviate from a predetermined work area,
wherein the controller is configured to calculate a distance between the work device and a boundary of the predetermined work area as the information related to the limiting function, and based on the calculated distance between the work device and the boundary of the predetermined work area, calculate the release pressure and controls the solenoid valve to output the calculated release pressure to the anti-drop valve.

5. The work machine according to claim 4,
wherein the controller is configured to select greater one of a release pressure that varies according to the distance between the work device and the boundary of the predetermined work area, and a release pressure corresponding to the pilot pressure of the pilot solenoid valve that rotates the connecting member downward, and control the solenoid valve to output the selected release pressure to the anti-drop valve.
